(19) United States
(12) Patent Application Publication
(10) Pub. No.: US 2018/0105939 A1
(43) Pub. Date: Apr. 19, 2018

(54) DIE-CAST ALUMINIUM ALLOY PIECE, AND PROCESSING METHOD AND MOBILE TERMINAL THEREFOR

(71) Applicants: GUANGDONG JANUS INTELLIGENT GROUP CORPORATION LIMITED, Guangdong (CN); DONGGUAN JANUS ELECTRONIC PRECISION COMPONENTS CO., LTD., Guangdong (CN)

(72) Inventors: JIANMING YANG, GUANGDONG (CN); SHOUDE XIE, GUANGDONG (CN); CHANGMING WANG, GUANGDONG (CN)

(21) Appl. No.: 15/552,226

(22) PCT Filed: Aug. 24, 2015
(86) PCT No.: PCT/CN2015/087956

§ 371 Date: Aug. 18, 2017

(30) Foreign Application Priority Data
Jun. 23, 2015 (CN) 201510355200.3

(51) Int. Cl. C23C 28/00; B05D 7/14; C25D 11/16; C25D 11/24

(52) U.S. Cl. CPC C23C 28/345; B05D 7/14; C25D 11/246; C25D 11/16; C23C 28/32

(57) ABSTRACT

Provided is a method for processing a die-cast aluminum alloy piece, comprising the following steps: performing a strengthening treatment on a die-cast aluminum alloy piece body (10) using a strengthening liquid, so as to form an organosilicon hardened layer (20) on the surface of the die-cast aluminum alloy piece body (10); forming an aluminum film layer (30) on the organosilicon hardened layer (20) by means of vacuum coating; performing an anodic oxidation treatment on the aluminum film layer (30), so that a part of the aluminum film layer (30) is oxidized to form an anodic oxidation layer (40), wherein the ratio of the thickness of the anodic oxidation layer (40) to that of the aluminum film layer (30) is (1-3):1; and performing a hole sealing treatment on the anodic oxidation layer (40). The invention further, relates to a die-cast aluminum alloy piece and a mobile terminal using the die-cast aluminum alloy piece.

### FIELD OF THE INVENTION

The present disclosure relates to a processing of a die-cast aluminum alloy piece, and more particularly relates to a die-cast aluminum alloy piece and a processing method thereof, and a mobile terminal using the die-cast aluminum alloy piece.

### BACKGROUND OF THE INVENTION

Aluminum alloy has been used by many manufacturers to produce notebook housing, smart phone housing due to the features of small density, high thermal conductivity, good plasticity. However, because the aluminum alloy has an active chemical property, a layer of amorphous oxide film is easily formed in the air, such that the surface thereof will lose the metallic luster, which to a certain extent limits the application of aluminum alloy. To meet the requirements of a fashion appearance of the smart mobile terminal, 6 series and 7 series of aluminum alloys are employed as raw materials to manufacture the housing of the smart mobile terminals, When the 6 series and 7 series of aluminum alloys are processed, they are firstly stamped, and then subjected to dozens of computer numerical control (CNC) machining processes to form the housing profile, and then subjected to an anodic oxidation treatment, thus an aluminum alloy with a certain appearance requirement is obtained. According to this conventional process, although the obtained aluminum alloy housing has metallic luster and a good appearance, the processing process is complicated, and the 6 series and 7 series of aluminum alloy raw material is expensive, thus resulting a high processing cost.

The conventional die-cast aluminum alloys are generally die-cast aluminum alloys of models ADC3-ADC12. Si, Mg and Fe contents of these die-cast aluminum alloys are very high, therefore, if the die-cast aluminum alloys are subjected to the anodic oxidation treatment, Al—Mg—Si—Fe and other intermetallic compounds may be formed. In addition, the high content of Si may form silicon particles during anodic oxidation. All of the above will cause some defects, such as oxide film becomes black, blue, milky white and the like, thus affecting the appearance. Therefore it is difficult to perform a surface decoration to the die-casting aluminum alloy simply by anodic oxidation.

### SUMMARY OF THE INVENTION

Accordingly, it is necessary to provide a die-cast aluminum alloy piece with lower cost and better appearance, and a surface treatment method thereof.

A die-cast aluminum alloy piece includes: a die-cast aluminum body; an organosilicon hardened layer disposed on the die-cast aluminum body; an aluminum film layer disposed on the silicone hardened layer; and an anodic oxide layer, wherein a ratio of a thickness of the anodic oxide layer to a thickness of the aluminum film layer is (1 to 3):1.

A processing method of a die-cast aluminum alloy piece, comprising the following steps of:

step one, performing an strengthening treatment to a die-cast aluminum body using a reinforcing solution, and forming an organosilicon hardened layer on a surface of the die-cast aluminum body;

step two, forming an aluminum film layer on the organosilicon hardened layer via a vacuum coating method;

step three, performing an anodic oxidation treatment to the aluminum film layer, thus oxidizing partial aluminum film layer to form an anodic oxide layer, wherein a ratio of a thickness of the anodic oxide layer to a thickness of the aluminum film layer is (1 to 3):1; and

step four, performing a sealing treatment to the anodic oxide layer.

A mobile terminal includes a housing, which is made of a die-cast aluminum alloy piece formed according to the foregoing processing method.

Upon the above process, the organosilicon hardened layer, the aluminum film layer, and the anodic oxide layer are subsequently formed on the die-cast aluminum alloy body. In the die-cast aluminum alloy piece described above, the aluminum film layer can be seen through the transparent anodic oxide layer, such that the die-cast aluminum alloy has a softer and delicate metallic texture, and a better appearance effect. Since the above-mentioned processes are carried out for the die-cast aluminum alloy, the appearance effect of the 6-series and 7-series aluminum alloy can be achieved by die-casting the aluminum alloy, thus greatly reducing the cost of the materials. Additionally, the process complexity is also significantly reduced due to die-casting molding, there is no need for dozens of CNC processes. Through the strengthening, vacuum coating, as well as the anodic oxidation treatment, the process is simple and controllable, thus it is suitable for large-scale industrial production applications.

### BRIEF DESCRIPTION OF THE DRAWINGS

These and other objects, advantages, purposes and features will become apparent upon review of the following specification in conjunction with the drawings. The components in the drawings are not necessarily drawn to scale, the emphasis instead being placed upon clearly illustrating the principles of the present disclosure.

FIG. 1 is a schematic view of a die-cast aluminum alloy according to an embodiment; and

FIG. 2 is a flowchart of a surface treatment method of the die-cast aluminum alloy piece according to an embodiment.

### DETAILED DESCRIPTION OF THE EMBODIMENTS

To illustrate the technical solutions according to the embodiments of the present invention more clearly, the accompanying drawings for describing the embodiments or the prior art are introduced briefly in the following. Embodiments of the invention arc described more fully hereinafter with reference to the accompanying drawings. The various embodiments of the invention may, however, be embodied in many different forms and should not be construed as limited to the embodiments set forth herein.

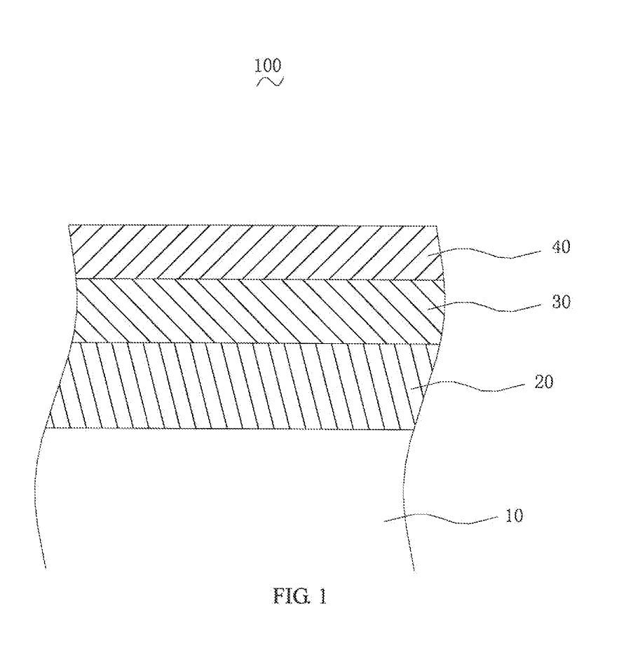

Referring to FIG. 1, an embodiment or a die-cast aluminum alloy piece 100 includes a die-cast aluminum alloy body 10. The piece 100 further includes an organosilicon hardened layer 20, an aluminum film layer 30, and an anodic oxide layer 40, which are successively disposed on a surface of the die-cast aluminum alloy body 10. The organosilicon hardened layer 20 consists essentially of silicone resin, and has a thickness ranging from 3 μm to 8 μm. The anodic oxide layer 40 consists essentially of alumina. A ratio of a thickness of the anodic oxide layer 40 to a thickness of the aluminum film layer 30 is (1 to 3):1, and a sum of the thicknesses of the anodic oxide layer and the aluminum film layer is in -a range of 5 μm to 15 μm.

In the die-cast aluminum alloy piece 100 described above, the aluminum film layer 30 can be observed through the transparent anodic oxide layer 40, such that the die-cast aluminum alloy has a softer and delicate metallic texture, and a better appearance effect.

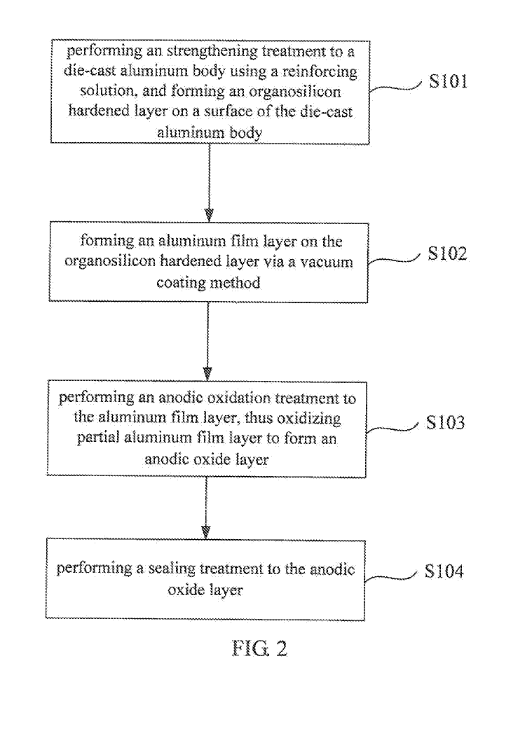

Referring also to FIG. 2, a processing method of the die-cast aluminum alloy piece 100 includes the following steps of:

In step S101, an strengthening treatment is performed to a die-cast aluminum alloy body using a reinforcing solution, and an organosilicon, hardened layer is formed on a surface of the die-cast aluminum body.

Prior to the strengthening treatment, the die-cast aluminum alloy body is firstly placed in acetone or anhydrous ethanol for ultrasonic cleaning for 10 to 30 minutes, so as to remove impurities (such as oil) on the surface of the die-cast aluminum alloy.

Forming the organosilicon hardened layer by the strengthening treatment can on the one hand increase the surface hardness of the die-cast aluminum alloy, thus facilitating subsequent aluminum plating, on the other hand, the organosilicon hardened layer helps to improve the transmittance of the die-cast aluminum alloy surface, such that after aluminum plating, the die-cast aluminum alloy below the organosilicon hardened layer and an aluminum film layer above the organosilicon hardened layer can cooperatively enhance the overall metal texture of die cast aluminum alloy surface.

In the present step, the die-cast aluminum alloy body can be a die-casting aluminum alloy obtained by a die-casting aluminum raw materials subjected to a conventional die-casting treatment. After die-casting molding, the shape and appearance of the die-casting aluminum alloy can also be improved by punching, polishing and other processes. Alternatively, the die-cast aluminum alloy body can be placed into an injection mold for injection molding to form a combination part of die-cast aluminum alloy and plastic piece.

In the present step, the reinforcing solution includes silicone resin, flexible resin, and auxiliary. In terms of weight percentage, the reinforcing solution includes 60% to 80% of silicone resin, 20% to 36% of flexible resin, and 0 to 4% of auxiliary. The auxiliary includes an adhesion enhancer and a defoamer. The above components are commercially available from KR-400 (silicone coating agent), KR-5230 (silicone polyester resin), KS-508 (silicone ant foaming agent), and KBM-503 (silane coupling agent), manufactured by Shin-Etsu Chemical Co., Ltd. When the die-cast aluminum alloy is subjected to the strengthening treatment by the reinforcing solution of above-mentioned components, not only an organosilicon hardened layer is formed on the surface of the die-cast aluminum alloy, a surface flatness can also be ensured, such that the aluminum film layer obtained by subsequent vacuum coating can reflect more bright metallic luster. Further preferred.

Specifically, the cleaned die-cast aluminum alloy body is immersed in a reinforcing tank containing the reinforcing solution at a temperature of 15° C. to 25° C. for 1 to 3 minutes to perform the strengthening treatment.

In step 102, an aluminum film layer is formed on the organosilicon hardened layer via a vacuum coating method.

Specifically, the die-cast aluminum alloy body formed with the organosilicon hardened layer is placed in a vacuum chamber of the coating machine; a pressure in the vacuum chamber is maintained, between 0.01 Pa and 0.09 Pa via a vacuum pump; argon gas having a purity of 99.99% or more is introduced into the vacuum chamber, and an aluminum wire having a purity of 99.99% or more is placed on an evaporation boat inside the vacuum chamber. Certain evaporation current is applied, thus coating the aluminum wire to the organosilicon hardened layer. The thickness of the formed aluminum film layer is controlled to be in a range of 5 μm to 1.5 μm by controlling the current and time applied during the evaporation.

In the present embodiment, prior to step S102, the method further includes a plasma cleaning step in a vacuum chamber: maintaining a pressure in the vacuum chamber between 1×10⁻⁴ Pa to 9×10⁻⁴ Pa; introducing argon gas having a purity of 99.99% or more into the vacuum chamber; cleaning the die-cast aluminum alloy body treated in step S101 using a plasma cleaning gun for 5 to 30 minutes, so as to further remove surface impurities. By removing the surface impurities using the plasma cleaning gun in the vacuum chamber, the aluminum film layer formed after the evaporation coating can be more easily adhered to the die-cast aluminum alloy, thus making the two tightly bonded.

In step S103, an anodic oxidation treatment is performed to the aluminum film layer, thus partial aluminum film layer is oxidized to form an anodic oxide layer, wherein a ratio of a thickness of the anodic oxide layer to a thickness of the aluminum film layer is (1 to 3):1.

In the present step, an oxo acid solution used in the anodic oxidation treatment can be a phosphoric acid solution and a sulfuric acid solution of 10% to 20% by mass, preferably sulfuric acid. Partial aluminum film layer on the surface of the die-cast aluminum alloy can be oxidized into the anodic oxide layer through the anodic oxidation treatment. By controlling, the process parameters of the anodic oxidation treatment, such as temperature, current, time and the like, the ratio of the thickness of the anodic oxide layer to the thickness of the aluminum film layer can be controlled to be (1 to 3):1. If the thickness of the anodic oxide layer is too thick, the binding force between the anodic oxide layer and the aluminum film layer is not enough, thus the two cannot be well combined. If the thickness is too thin, the aluminum film layer cannot be well protected, and the appearance effect after oxidation may not meet the requirements.

In step S104, a sealing treatment is performed to the anodic oxide layer.

During the process of anodic oxidation, small pores are formed on the anodic oxide layer. The pores are closed by this sealing treatment, such that the surface pores of the anodic oxide layer became smaller and the surface was smooth, i.e. the die-cast aluminum alloy with a smooth surface can be obtained. Specifically, the anodized die-cast aluminum alloy body is cleaned in a deionized water tank of 15° C. to 25° C. for 10 to 15 minutes, then the anodized die-cast aluminum alloy body is subjected to the sealing treatment in a deionized water tank of 75° C. to 85° C. for 10 to 15 minutes. Compared with the case where the sealing agent or the plating is used, this sealing treatment can achieve sealing with a lower cost. In addition, if the anodized die-cast aluminum alloy has a clean surface, it can be directly subjected to the sealing treatment in a deionized water tank of 75° C. to 85° C. for 10 to 15 minutes without the cleaning step.

Upon the above process, the organosilicon hardened layer, the aluminum film layer, and the anodic oxide layer are subsequently formed on the die-cast aluminum alloy body. In the die-cast aluminum alloy piece described above, the aluminum film layer can be observed through the transparent anodic oxide layer, such that fhe die-cast aluminum alloy has a softer and delicate metallic texture, and a better appearance effect. Since the above-mentioned processes are carried out for the die-cast aluminum alloy. the appearance effect similar to the 6-series and 7-series aluminum alloy can be achieved by die-casting the aluminum alloy, thus greatly reducing the cost of the materials. Additionally, the process complexity is also significantly reduced due to die-casting molding, there is no need for dozens of CNC processes. Through the strengthening, vacuum coating, as well as the anodic oxidation treatment, the process is simple and controllable, thus it is suitable for large-scale industrial production applications.

If the above-mentioned die-casting aluminum alloy is applied to specific occasions, it can be processed into required housing profile by removing redundant accessories by a simple CNC process. It should be noted that, since the housing with the required main profile has already been obtained during previous die-casting, the CNC process is only employed to assist the removal of redundant accessories, rather than process the required housing profile primarily by the CNC process. Therefore, even though the CNC process is involved, it only plays a supporting role, the whole process is significantly simplified compared with conventional process of forming the housing by aluminum alloy.

The present embodiment also provides a mobile terminal including a main body and a housing attached to the main body. The housing is made of a die-cast aluminum alloy piece formed according to the foregoing processing method. The mobile terminals can be mobile phones, tablet PCs, laptops, PDAs, digital cameras and so on. The die-cast aluminum alloy obtained by the above-described method can be used as the housing for the mobile terminal. The housing not only has a metallic luster, but also has a better appearance. Meanwhile, the material costs and processing costs of the housing are lower than the housing made of 6 series and 7 series of aluminum alloy on the market.

The following are the specific examples.

### EXAMPLE ONE

The die-cast aluminum alloy, model ADC12, was placed in acetone for ultrasonic cleaning for 20 minutes, so as to remove impurities on the surface of the die-cast aluminum alloy. The cleaned die-cast aluminum alloy was immersed in a reinforcing tank containing the reinforcing solution at a temperature of 20° C. for 3 minutes to perform the strengthening treatment, thus forming an organosilicon hardened layer of 3 μm on a surface of the die-cast aluminum body. According to the weight percentage, the reinforcing solution included 80% of the silicone resin of the model KR-400, 18% of the flexible resin of model KR-5230 and 2% of the auxiliary of model KBM-503. The die-cast aluminum alloy body formed with the organosilicon hardened layer was placed in a vacuum chamber of the coating machine, a pressure in the vacuum chamber was maintained at 5×10⁻⁴ Pa, argon gas having a purity of 99.99% or more was introduced into the vacuum chamber. The die-cast aluminum alloy body was cleaned for 10 minutes using a plasma cleaning gun, an aluminum wire having a purity of 99.99% or more was coated on the organosilicon hardened layer to form an aluminum film layer having a thickness of 12μm. Next, the aluminum film layer was subjected to anodic oxidation using a sulfuric acid solution with a mass percentage of 20% under a temperature of 20° C., a current of 4 amps for 15 minutes, and, an anodic oxide layer having a thickness of 4 μm was finally obtained. The anodized die-cast aluminum alloy body was cleaned in a deionized water tank of 20° C. for 10 minutes, then it was subjected to the sealing treatment in a deionized water tank of 80° C. for 10 minutes.

### EXAMPLE TWO

The die-cast aluminum alloy, model ADC12, was placed in acetone for ultrasonic cleaning for 20 minutes, so as to remove impurities on the surface of the die-east aluminum alloy. The cleaned die-cast aluminum alloy was immersed in a reinforcing tank containing the reinforcing solution at a temperature of 20° C. for 3 minutes to perform the strengthening treatment, thus forming an organosilicon hardened layer of 5 μm on a surface of the die-cast aluminum body. According to the weight percentage, the reinforcing solution included 70% of the silicone resin of the model KR-400, 28% of the flexible resin of model KR-5230 and 2% of the auxiliary of model KBM-503. The die-cast aluminum alloy body formed with the organosilicon hardened layer was placed in a vacuum chamber of the coating machine, a pressure in the vacuum chamber was maintained at 2×10^{31 4} Pa, argon, gas having a purity of 99.99% or more was introduced into the vacuum chamber. The die-cast aluminum alloy body was cleaned for 15 minutes using a plasma cleaning gun, an aluminum wire having a purity of 99.99% or more was coated on the organosilicon hardened layer to form an aluminum film layer having a thickness of 12 μm. Next, the aluminum film layer was subjected to anodic oxidation using a sulfuric acid solution with a mass percentage of 20% under a temperature of 20° C., a current of 4 amps for 15 minutes, and an anodic oxide layer having a thickness of 4 μm was finally obtained. The anodized die-cast aluminum alloy body was cleaned in a deionized water tank of 20° C. for 10 minutes, then it was subjected to the sealing treatment in a deionized water tank of 80° C. for 10 minutes.

### EXAMPLE THREE

The die-cast aluminum alloy, model ADC12, was placed in acetone for ultrasonic cleaning tier 20 minutes, so as to remove impurities on the surface of the die-cast aluminum alloy. The cleaned die-cast aluminum alloy was immersed in a reinforcing tank containing the reinforcing solution at a temperature of 20° C. for 3 minutes to perform the strengthening treatment, thus forming an organosilicon hardened layer of 8 μm on a surface of the die-cast aluminum body. According to the weight percentage, the reinforcing solution included 60% of the silicone resin of the model KR-400, 38% of the flexible resin of model KR-5230 and 2% of the auxiliary of model KBM-503. The die-cast aluminum alloy body formed with the organosilicon hardened layer was placed in a vacuum chamber of the coating machine, a pressure in the vacuum chamber was maintained at 8×10⁻⁴ Pa, argon gas having a purity of 99.99% or more was introduced into the vacuum chamber. The die-cast aluminum alloy body was cleaned for 20 minutes using a plasma cleaning gun, an aluminum wire having a purity of 99.99% or more was coated on the organosilicon hardened layer to form an aluminum film layer having a thickness of 12 μm. Next, the aluminum film layer was subjected to anodic oxidation using a sulfuric acid solution with a mass percentage of 15% under a temperature of 18° C., a current of 4 amps for 20 minutes, and an anodic oxide layer having a thickness of 4 μm was finally obtained. The anodized die-cast aluminum alloy body was cleaned in a deionized water tank of 20° C. for 10 minutes, then it was subjected to the sealing treatment in a deionized water tank of 80° C. for 10 minutes.

### COMPARATIVE EXAMPLE ONE

The process of Comparative Example one was similar to that of Example one, the difference was that, a commercially available hardening solution, of model FC-100 was used to replace the reinforcing solution of Example one, while the rest process conditions remained unchanged.

### COMPARATIVE EXAMPLE TWO

The process of Comparative Example one was similar to that of Example one, the difference was that, a commercially available hardening solution of model KY90HC-27 was used to replace the reinforcing solution of Example one, while the rest process conditions remained unchanged.

Performance Testing

| | Surface | Adhesion | |
|---|---|---|---|
| Test items | hardness | (Cross-Cut Test) | Surface color |
| Example one | 6H | 5B | Pure transparent |
| Example two | 5H | 5B | Pure transparent |
| Example three | 4H | 5B | Pure transparent |
| Comparative | 3H | 4B | Pure transparent |
| Example one | | | |
| Comparative | 5H | 5B | Transparent and |
| Example two | | | yellowish |

It can be inferred from the above performance test that, the die-cast aluminum alloy processed by the embodiment of the present invention has a high surface hardness, a better adhesion, and a better appearance.

Although the respective embodiments have been described one by one, it shall be appreciated that the respective embodiments will not be isolated. Those skilled in the art can apparently appreciate upon reading the disclosure of this application that the respective technical features invohcd in the respective embodiments can be combined arbitrarily between the respective embodiments as long as they have no collision with each other.

Although the description is illustrated and described herein with reference to certain embodiments, the description is not intended to be limited to the details shown. Modifications may be made in the details within the scope and range equivalents of the claims.

What is claimed is:

1. A die-cast aluminum alloy piece, comprising:
a die-cast aluminum alloy body:
an organosilicon hardened layer disposed on the die-cast aluminum body;
an aluminum film layer disposed on the silicone hardened layer; and
an anodic oxide layer, wherein a ratio of a thickness of the anodic oxide layer to a thickness of the aluminum film layer is (1 to 3):1.

2. The die-cast aluminum alloy piece of claim 1, wherein the thickness of the anodic oxide layer is in a range of 3 μm to 8 μm.

3. The die-cast aluminum alloy piece of claim 1, wherein a sum of the thicknesses of the anodic oxide layer and the aluminum film layer is in a range of 5μm to 15 μm.

4. A processing method of a die-cast aluminum alloy piece, comprising the following steps of:
step one, performing an strengthening treatment to a die-east aluminum body using a reinforcing solution, and forming an organosilicon hardened layer on a surface of the die-cast aluminum body;
step two, forming an aluminum film layer on the organosilicon hardened layer via a vacuum coating method;
step three, performing an anodic oxidation treatment to the aluminum film layer, thus oxidizing partial aluminum film layer to form an anodic oxide layer, vvherein a ratio of a thickness of the anodic oxide layer to a thickness of the aluminum film layer is (1 to 3):1; and
step four, performing a sealing treatment to the anodic oxide layer.

5. The method of claim 4, wherein prior to step one, the method further comprises placing the die-cast aluminum alloy body in acetone or anhydrous ethanol for ultrasonic cleaning for 10 to 30 minutes.

6. The method of claim 4, wherein in terms of weight percentage, the reinforcing solution comprises 60% to 80% of a silicone resin, 20% to 36% of a flexible resin, and 0 to 4% of auxiliary; wherein the auxiliary comprises an adhesion enhancer and a defoamer.

7. The method of claim 4, wherein the step two comprises: placing the die-cast aluminum alloy body formed with the organosilicon hardened layer in a vacuum chamber of the coating machine; maintaining a pressure in the vacuum chamber between 0.01 Pa and 0.09 Pa via a vacuum pump; introducing argon gas having a purity of 99.99% or more into the vacuum chamber with, and placing an aluminum wire having a purity of 99.99% or more on an evaporation boat inside the vacuum chamber. Applying evaporation current and coating the aluminum wire to the organosilicon hardened layer.

8. The method of claim 4, wherein in step two, a sum of the thicknesses of the anodic oxide layer and the aluminum film layer is in a range of 5 μm to 15 μm.

9. The method of claim 7, wherein prior to step two, the method further comprises:
maintaining a pressure in the vacuum chamber between 1×10⁻4 Pa to 9×10⁻⁴ Pa; filling the vacuum chamber with argon gas having a purity of 99.99% or more; cleaning the die-cast aluminum alloy body treated in step one using a plasma cleaning gun for 5 to 30 minutes,

10. The method of claim 4, wherein in step three, the anodic oxidation treatment is performed using sulfuric acid or phosphoric acid with a mass percentage of 10% to 20%.

11. The method of claim 4, wherein in step four, the anodized die-east aluminum alloy body is cleaned in a deionized water tank of 15° C. to 25° C. for 10 to 15 minutes, then the anodized die-east aluminum alloy body is subjected to the sealing treatment in a deionized water tank of 75° C. to 85° C. for 10 to 15 minutes.

12. A mobile terminal comprising a housing formed by a die-cast aluminum alloy piece of claim 1.
